(19) United States
(12) Patent Application Publication
(10) Pub. No.: US 2015/0039993 A1
(43) Pub. Date: Feb. 5, 2015

(54) DISPLAY DEVICE AND DISPLAY METHOD

(71) Applicant: KABUSHIKI KAISHA TOSHIBA, Tokyo (JP)

(72) Inventors: Dai Ishimaru, Koganei-shi (JP); Toshihiro Morohoshi, Kawasaki-shi (JP)

(73) Assignee: KABUSHIKI KAISHA TOSHIBA, Tokyo (JP)

(21) Appl. No.: 14/176,374

(22) Filed: Feb. 10, 2014

(30) Foreign Application Priority Data
Jul. 31, 2013 (JP) 2013-159791

(51) Int. Cl. G06F 17/22

(52) U.S. Cl. CPC G06F 17/2247
USPC 715/234

(57) ABSTRACT

According to one embodiment, a display device includes a display, a recognition controller, a converter, a browser and a display processor. The recognition controller is configured to analyze broadcast video comprising a two-dimensional code and to recognize the two-dimensional code. The converter is configured to convert the recognized two-dimensional code into address information. The browser is configured to access a web page indicated by the address information and to display the web page on a browser screen. The display processor is configured to display a screen of the broadcast video and the browser screen on the display at the same time.

### CROSS-REFERENCE TO RELATED APPLICATIONS

This application is based upon and claims the benefit of priority from Japanese Patent Application No. 2013-159791, filed Jul. 31, 2013, the entire contents of which are incorporated herein by reference.

### FIELD

Embodiments described herein relate generally to a display device and a display method.

### BACKGROUND

Conventionally, there has been widely known television devices having a Web browser function. Such television devices can use the Web browser function to access various types of Web sites, thereby displaying a Web page.

To access a certain Web page in such a conventional television device, a user needs to input address information, such as a long uniform resource locator (URL), from a remote controller or the like. Alternatively, the user needs to have indirect access, such as displaying the Web page by searching for the certain Web site in a search site. Thus, the display operation of the Web page is complicated.

In addition, the user frequently views broadcast video in such a television device. Interruption of the broadcast video, such as sudden switching of display from the broadcast video to the Web page, is inconvenient for the user.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a configuration of a digital television according to a first embodiment;

FIG. 2 is an exemplary block diagram of a functional configuration of a controller of the digital television in the first embodiment;

FIG. 3 is an exemplary flowchart of a process of display processing in the first embodiment;

FIG. 4 is an exemplary view of a two-dimensional code displayed in broadcast video in the first embodiment;

FIG. 5 is an exemplary view of a user selection screen in the first embodiment;

FIGS. 6A to 6C are exemplary views of display examples of the broadcast video and a Web page displayed by a Web browser in the first embodiment;

FIG. 7 is an exemplary block diagram of a functional configuration of a controller of a digital television according to a second embodiment;

FIG. 8 is an exemplary view of a data structure of history data in the second embodiment;

FIG. 9 is an exemplary view of a display example of the history data in the second embodiment;

FIG. 10 is an exemplary flowchart of a process of display processing in the second embodiment;

FIG. 11 is an exemplary view for explaining a third embodiment;

FIG. 12 is an exemplary block diagram of a functional configuration of a controller of a digital television in the third embodiment; and

FIG. 13 is an exemplary view of generation of a two-dimensional code performed by a mobile terminal in the third embodiment.

### DETAILED DESCRIPTION

In general, according to one embodiment, a display device comprises a display, a recognition controller, a converter, a browser and a display processor. The recognition controller is configured to analyze broadcast video comprising a two-dimensional code and to recognize the two-dimensional code. The converter is configured to convert the recognized two-dimensional code into address information. The browser is configured to access a web page indicated by the address information and to display the web page on a browser screen. The display processor is configured to display a screen of the broadcast video and the browser screen on the display at the same time.

Exemplary embodiments of a display device and a display method are described below in greater detail with reference to the accompanying drawings.

### First Embodiment

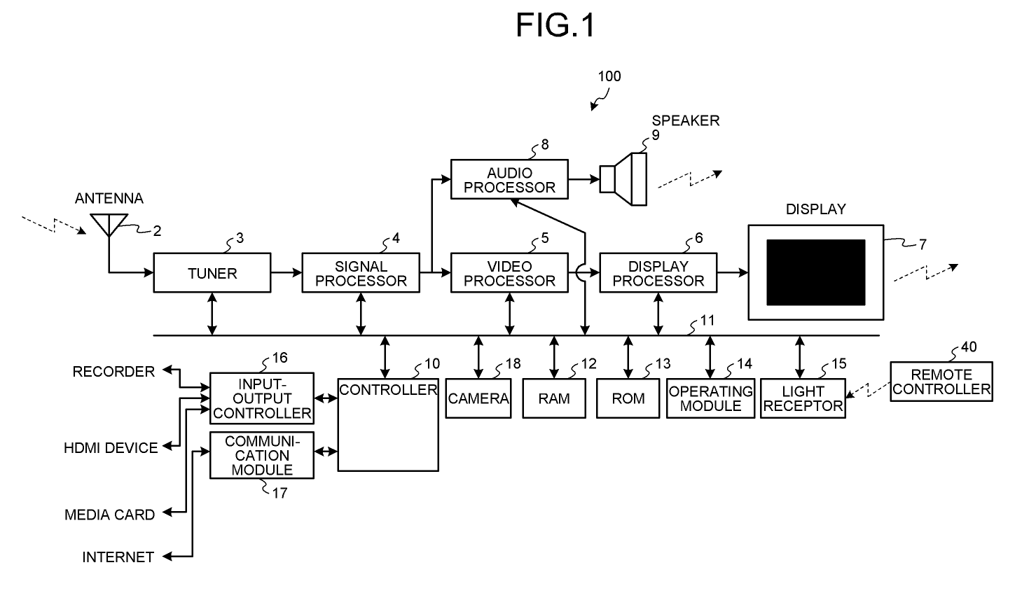

As illustrated in FIG. 1, a digital television 100 according to an embodiment mainly comprises an antenna 2, a tuner 3 for receiving digital broadcasting, a signal processor 4, a video processor 5, a display processor 6, a display 7, an audio processor 8, a speaker 9, a controller 10, a communication line 11, a random access memory (RAM) 12, a read-only memory (ROM) 13, an operating module 14, a light receptor 15, an input-output controller 16, a communication module 17, and a camera 18.

The antenna 2 receives digital broadcasting, such as BS, CS, and terrestrial broadcasting. The tuner 3 selects a channel for viewing instructed by a user. The signal processor 4 extracts and processes a signal demodulated by the tuner 3 and a signal received from the input-output controller 16 as various types of digital signals under the control of the controller 10. The signal processor 4 separates an input signal into a video signal and an audio signal. The signal processor 4 outputs the video signal to the video processor 5 and outputs the audio signal to the audio processor 8.

The video processor 5 performs processing for adjusting a video signal received from the signal processor 4 into a proper screen size and processing for removing noise contained in the video signal as image-quality processing for improving the image quality of video, for example.

The display processor 6 performs processing for displaying a video signal output from the video processor 5 on the display 7. The display processor 6 superimposes on-screen display (OSD), such as character information, on the video signal output from the video processor 5. The display processor 6 displays a browser screen displayed by a Web browser, which will be described later, on the display 7. The display 7 displays the video signal on a screen. The user views the screen of the display 7, thereby viewing television video.

The audio processor 8 performs acoustic processing on an audio signal and amplifies the audio signal. The speaker 9 outputs the audio signal as audio. The user listens to the audio output from the speaker 9, thereby listening to television audio.

The controller 10 controls each module of the digital television 100. The controller 10 is a processing unit that can perform sequence processing. The controller 10 loads and sequentially executes computer programs stored in the ROM 13 on the RAM 12. Thus, the controller 10 outputs a control signal to each module of the digital television 100, thereby collectively controlling the operation of the digital television 100.

The communication line 11 connects the tuner 3, the signal processor 4, the video processor 5, the display processor 6, the audio processor 8, and the controller 10 to one another. The communication line 11 delivers data between the controller 10 and each of the tuner 3, the signal processor 4, the video processor 5, the display processor 6, and the audio processor 8. Specifically, the communication line 11 may be an IIC-bus, for example. The RAM 12 and the ROM 13 store therein various types of data and transmit and receive these pieces of data to and from the controller 10.

The operating module 14 is a switch that receives an operating instruction from the user. The light receptor 15 receives a signal output from a remote controller 40 (hereinafter, simply referred to as a “remote 40”) that receives the operating instruction from the user. The user operates various types of buttons and keys of the remote 40, thereby operating the digital television 100 and each device connected to the digital television 100.

The communication module 17 has a function to communicate with a server connected thereto via a network, such as the Internet. The communication module 17 requests information from the server and receives information transmitted from the server.

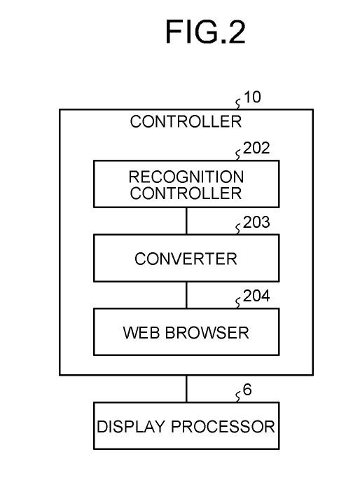

The following describes functions performed by the controller 10 in detail. As illustrated in FIG. 2, the digital television 100 mainly comprises a recognition controller 202, a converter 203, and a Web browser 204 as a functional configuration provided by the controller 10. FIG. 2 also illustrates the display processor 6 illustrated in FIG. 1 for the convenience of explanation.

The recognition controller 202 receives a video signal, that is, broadcast video from the video processor 5. The recognition controller 202 analyzes the broadcast video thus received, thereby recognizing (identifying) a two-dimensional code included in the broadcast video by image recognition processing. The two-dimensional code is a code obtained by converting a character string into a two-dimensional symbol. Examples of the two-dimensional code include a quick response (QR) code (registered trademark). In the present embodiment, a QR code (registered trademark) is used as an example of the two-dimensional code. The QR code (registered trademark) is a code obtained by converting a uniform resource locator (URL) corresponding to an address of a Web site on the network, such as the Internet. Hereinafter, a QR code (registered trademark) is referred to as a two-dimensional code for the convenience of explanation.

The URL of a home page of a manufacturer selling a product advertised in a commercial in broadcast video may possibly be embedded in the commercial as a two-dimensional code, for example. The recognition controller 202 analyzes the broadcast video for each frame, thereby recognizing the two-dimensional code embedded in the frame image.

The converter 203 converts the two-dimensional code recognized by the recognition controller 202 into the address information, that is, the URL represented by the two-dimensional code.

The Web browser 204 accesses the Web site of the URL converted from the two-dimensional code by the converter 203 to display a Web page on the browser screen. The display processor 6 starts the Web browser 204 to display both the screen of the broadcast video and the browser screen displayed by the Web browser 204 on the display 7 at the same time.

Whether to start the Web browser 204 immediately when the recognition controller 202 recognizes the two-dimensional code from the broadcast video is set by a setting flag of an automatic start mode stored in a storage medium, such as the RAM 12. If the setting flag of the automatic start mode is set to “ON”, the display processor 6 starts the Web browser 204 immediately. By contrast, if the setting flag of the automatic start mode is set to “OFF”, the display processor 6 does not start the Web browser 204 immediately and starts the Web browser 204 after inquiring of the user whether to start the Web browser 204.

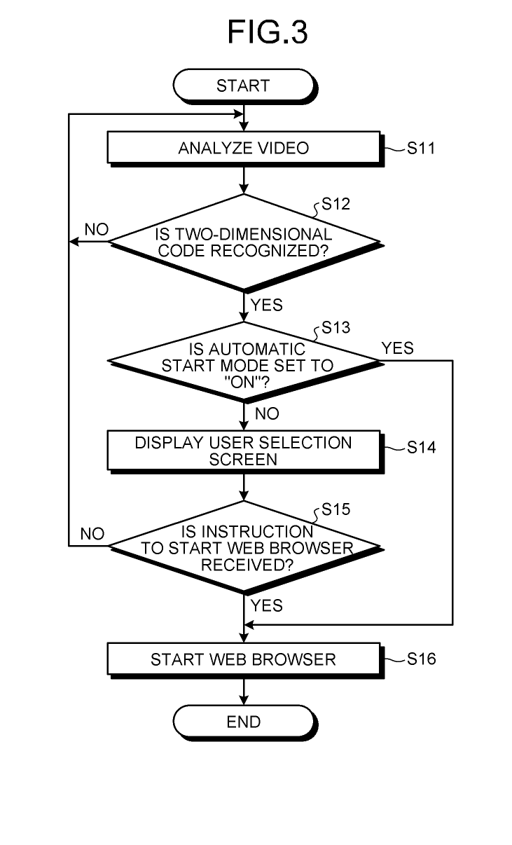

The following describes display processing performed by the digital television 100 configured as described above according to the present embodiment with reference to FIG. 3.

The recognition controller 202 acquires broadcast video from the video processor 5 and analyzes the broadcast video for each frame (S11). The recognition controller 202 determines whether a two-dimensional code is recognized from the broadcast video (S12). If no two-dimensional code is recognized from the broadcast video (No at S12), the recognition controller 202 repeats the processing at S11 and S12.

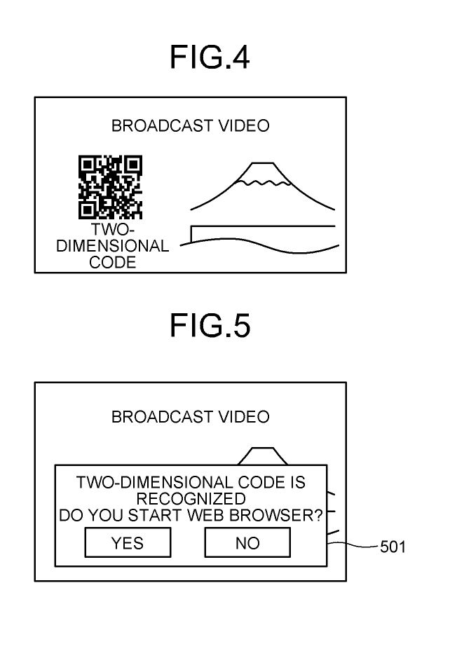

In the case of broadcast video illustrated in FIG. 4, the recognition controller 202 recognizes a two-dimensional code from the broadcast video.

Referring back to FIG. 3, if a two-dimensional code is recognized from the broadcast video (Yes at S12), the converter 203 converts the two-dimensional code thus recognized into a URL represented by the two-dimensional code. The display processor 6 refers to the RAM 12 or the like to determine whether the setting flag of the automatic start mode is set to “ON” (S13). If the setting flag of the automatic start mode is set to “ON” (Yes at S13), the system control goes to S16, and the display processor 6 starts the Web browser 204 immediately (S16).

By contrast, if the setting flag of the automatic start mode is set to “OFF” (No at S13), the display processor 6 does not start the Web browser 204 immediately and displays a user selection screen on the display 7 to inquire of the user whether to start the Web browser 204 (S14). As illustrated in an example of a user selection screen 501 of FIG. 5, a message on the user selection screen 501 inquires of the user whether to start the Web browser 204.

The display processor 6 waits for an instruction issued from the user through the user selection screen 501 (S15).

If the user selects “NO” on the user selection screen 501 with the remote 40 or the like to issue an instruction not to start the Web browser 204, the display processor 6 receives the instruction (No at S15) and does not start the Web browser 204. Subsequently, the system control is returned to S11.

By contrast, if the user selects “YES” on the user selection screen 501 with the remote 40 or the like to issue an instruction to start the Web browser 204, the display processor 6 receives the instruction at S15 (Yes at S15) and starts the Web browser 204 (S16).

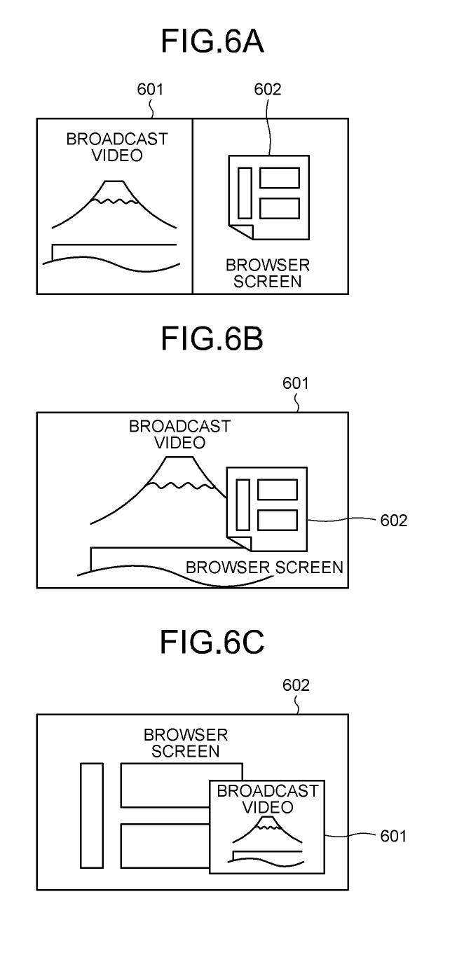

If the display processor 6 starts the Web browser 204, the Web browser 204 accesses the Web site of the URL converted by the converter 203. The Web browser 204 displays a Web page obtained by accessing the Web site on the browser screen. At this time, the display processor 6 displays both the screen of the broadcast video and the browser screen on which the Web page is displayed by the Web browser 204 on the display 7. The display processor 6, for example, displays a screen 601 of broadcast video and a browser screen 602 displayed by the Web browser 204 on respective screens arranged in parallel as illustrated in FIG. 6A.

Alternatively, the display processor 6 may display the screen 601 of the broadcast video and the browser screen 602 in a picture-in-picture display format for displaying one of the screen 601 of the broadcast video and the browser screen 602 in the other thereof on the display 7. FIG. 6B illustrates an example in which the browser screen 602 is displayed in the screen 601 of the broadcast video in the picture-in-picture format. FIG. 6C illustrates an example in which the screen 601 of the broadcast video is displayed in the browser screen 602 in the picture-in-picture format.

The display format of the screen 601 of the broadcast video and the browser screen 602 may be any format as long as it displays both of the screens and is not limited to the formats described above.

In the present embodiment, the digital television 100 recognizes a two-dimensional code from broadcast video, converts the two-dimensional code into a URL, and causes the Web browser 204 to access the URL, thereby displaying a Web page. As a result, the user need not specify an address, such as a long URL, or use an indirect method, such as displaying a desired Web page via a search site. This enables the user to display the Web page by a simply operation.

In the present embodiment, when the two-dimensional code is recognized from the broadcast video, the display processor 6 inquires of the user whether to start the Web browser 204 before starting the Web browser 204. Instead of replacing the screen of the broadcast video by the browser screen on which the Web page is displayed, the display processor 6 displays both the screen of the broadcast video and the browser screen on the display 7. Thus, the present embodiment can display the Web page in accordance with an intention of the user without interrupting the user's viewing the broadcast video. This is convenient for the user who is viewing the broadcast video.

### Second Embodiment

In a second embodiment, a digital television 100 stores therein a URL represented by a two-dimensional code recognized from broadcast video, a site name, information of a program relating to the two-dimensional code, and other data as history data.

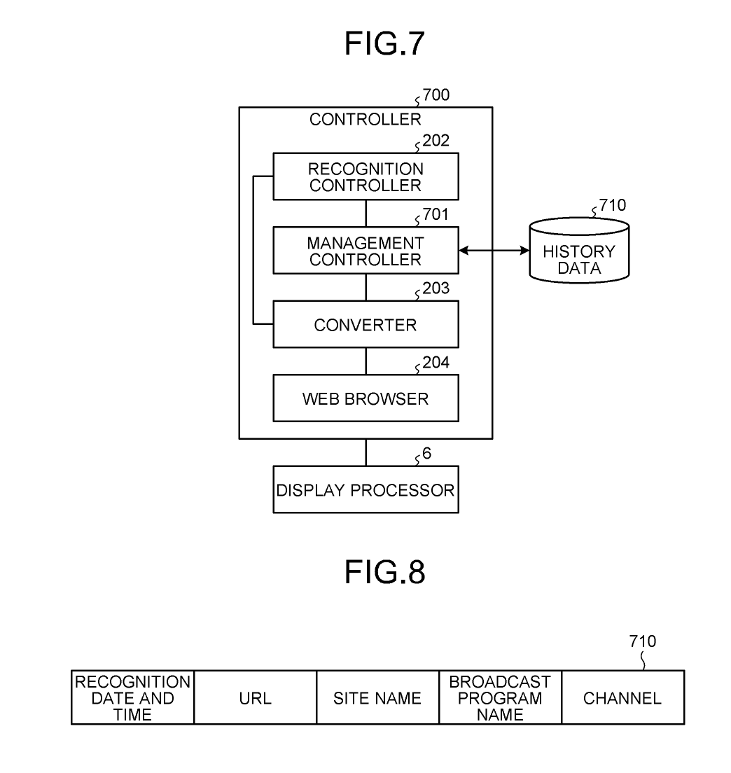

The configuration of the digital television 100 according to the second embodiment is similar to that of the first embodiment illustrated in FIG. 1. As illustrated in FIG. 7, a functional configuration of a controller 700 according to the present embodiment mainly comprises a recognition controller 202, a converter 203, a Web browser 204, and a management controller 701. FIG. 7 also illustrates the display processor 6 illustrated in FIG. 1 for the convenience of explanation. The recognition controller 202, the converter 203, and the Web browser 204 each have the same functions as those in the first embodiment.

If the recognition controller 202 recognizes a two-dimensional code from broadcast video, the management controller 701 stores and manages information relating to the two-dimensional code in chronological order in a storage medium, such as a RAM 12, as history data 710.

As illustrated in FIG. 8, the history data 710 records a recognition date and time at which the two-dimensional code is recognized, a URL represented by the two-dimensional code, a site name indicated by the URL, and program information, such as a broadcast program name and a channel of the broadcast video in which the two-dimensional code is included, in a manner associated with one another.

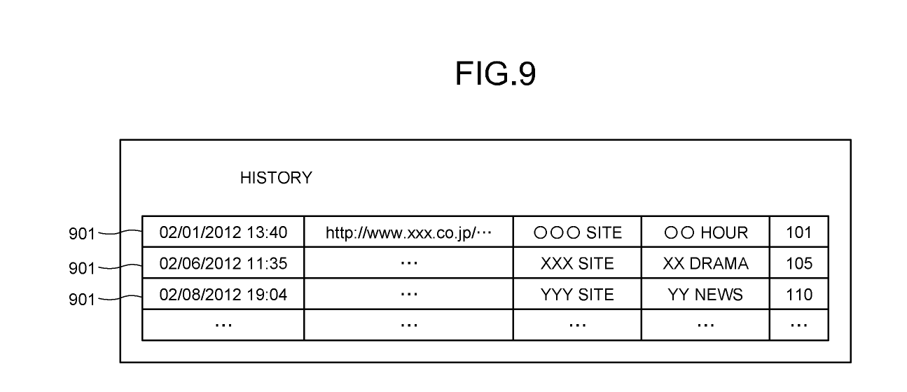

The display processor 6 reads the history data 710 from the RAM 12 or the like and displays the history data 710 on a display 7. As illustrated in FIG. 9, the display 7 displays a list of the history data 710. A reference numeral 901 denotes a display row corresponding to one piece of history data. If the user selects the display row 901 of desired history data with the remote 40 or the like on the screen illustrated in FIG. 9, the Web browser 204 starts and accesses the site of the URL in the display row 901 thus selected. Subsequently, the display processor 6 displays a Web page on the display 7.

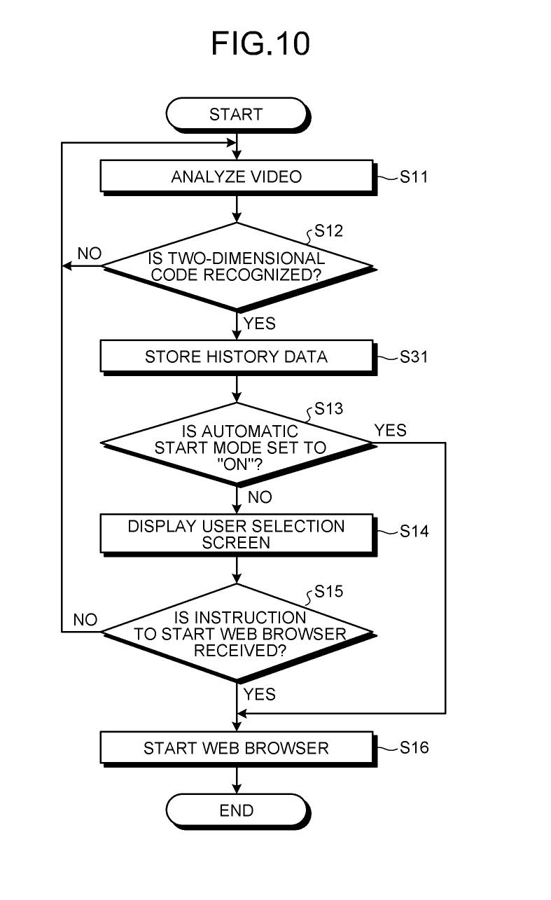

The following describes display processing according to the present embodiment configured as described above with reference to FIG. 10. Processing at S11 and S12 is performed in the same manner as in the first embodiment.

If a two-dimensional code is recognized at S12 (Yes at S12), the converter 203 converts the two-dimensional code into a URL. The management controller 701 stores a recognition date and time of the two-dimensional code, the URL converted from the two-dimensional code, a broadcast program name in which the two-dimensional code is recognized, and a channel of the broadcast program in a storage medium, such as the RAM 12, as history data (S31). Subsequent processing from S13 to S16 is performed in the same manner as in the first embodiment.

At this time, the management controller 701 registers a site name acquired by the Web browser starting at S16 and accessing the URL in the site name in the history data 710.

As described above, the present embodiment stores therein a URL represented by a two-dimensional code recognized from broadcast video, a site name, information of a program relating to the two-dimensional code, and other data as the history data 710. This can facilitate the user' s accessing a site previously accessed, which is convenient for the user.

### Third Embodiment

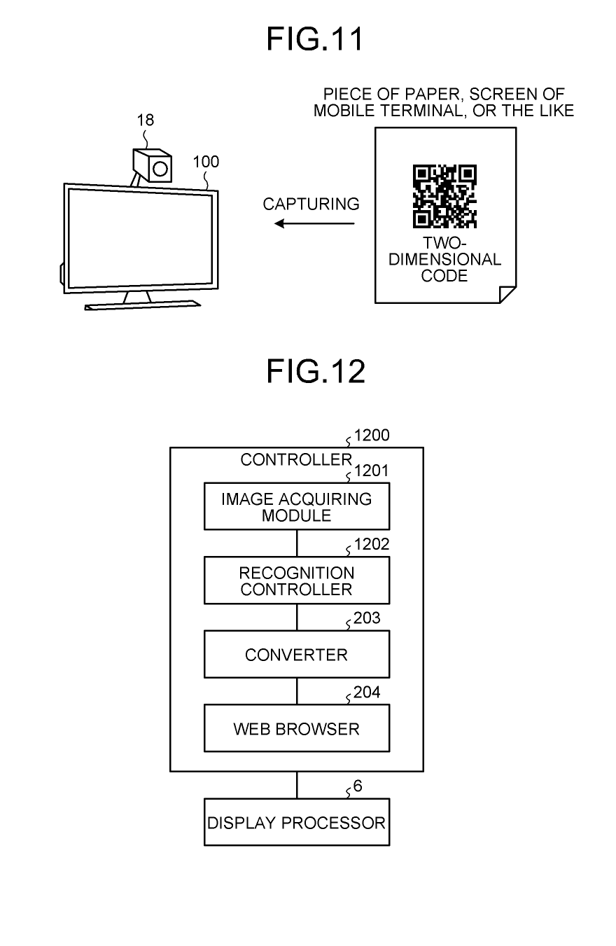

The first and the second embodiments recognize a two-dimensional code from broadcast video. A digital television 100 according to a third embodiment captures a piece of paper or a screen of a mobile terminal with a camera 18 provided to the digital television 100 and analyzes the captured image, thereby recognizing a two-dimensional code as illustrated in FIG. 11

The configuration of the digital television 100 according to the third embodiment is similar to that of the first embodiment illustrated in FIG. 1. As illustrated in FIG. 12, a functional configuration of a controller 1200 according to the present embodiment mainly comprises an image acquiring module 1201, a recognition controller 1202, a converter 203, and a Web browser 204. FIG. 12 also illustrates the display processor 6 illustrated in FIG. 1 for the convenience of explanation. The converter 203 and the Web browser 204 each have the same functions as those in the first embodiment.

The image acquiring module 1201 acquires a captured image obtained by capturing a piece of paper or a screen of a mobile terminal from the camera 18. The recognition controller 1202 according to the present embodiment analyzes broadcast video, thereby recognizing a two-dimensional code similarly to the first embodiment. In addition, the recognition controller 1202 analyzes the captured image acquired by the image acquiring module 1201, thereby recognizing a two-dimensional code. Display processing according to the present embodiment is the same as that in the first embodiment.

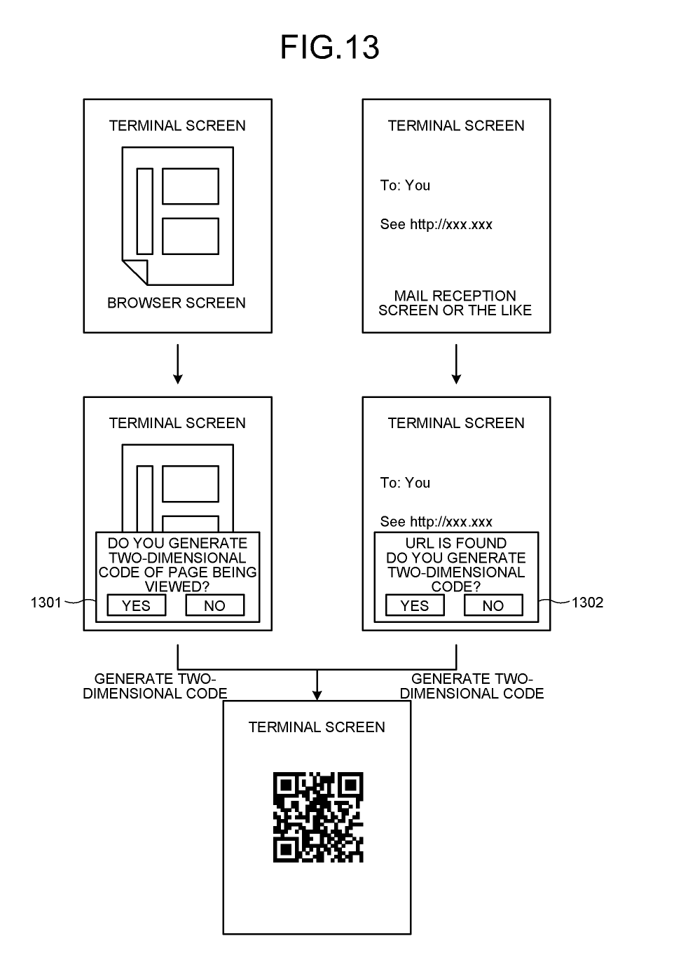

As illustrated in FIG. 13, the mobile terminal can generate a two-dimensional code from the URL of a Web page being viewed by the user and displayed by a browser of the mobile terminal. Furthermore, the mobile terminal can generate a two-dimensional code from a URL written on a received e-mail or a screen displayed by the browser. To generate a URL in this manner, the mobile terminal may inquire of the user whether to generate the two-dimensional code as illustrated in inquiry screens 1301 and 1302 of FIG. 13.

As described above, the present embodiment captures a piece of paper or a screen of a mobile terminal with the camera 18 provided to the digital television 100 and analyzes the captured image, thereby recognizing a two-dimensional code. This enables the user to display a Web page by a simply operation.

The Web page and the site of the URL may be associated with a broadcast program by the digital television 100 analyzing the captured image as long as they are sites relating to the broadcast program.

An assumption is made that the user browses a site relating to a broadcast program with a mobile terminal or the like while viewing broadcast video on the digital television 100, for example. In this case, the digital television 100 can recognize the URL of the site as a two-dimensional code, thereby displaying a Web page associated with the broadcast video. This further increases the convenience for the user.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device comprising:
a display;
a recognition controller configured to analyze broadcast video comprising a two-dimensional code and to recognize the two-dimensional code;
a converter configured to convert the recognized two-dimensional code into address information;
a browser configured to access a web page indicated by the address information and to display the web page on a browser screen; and
a display processor configured to display a screen of the broadcast video and the browser screen on the display at the same time.

2. The display device of claim 1, wherein the display processor is configured to display whether to start the browser on the display when the two-dimensional code is recognized and start the browser when an instruction to start the browser is received.

3. The display device of claim 1, wherein the display processor is configured to display the screen of the broadcast video and the browser screen individually on the display.

4. The display device of claim 3, wherein the display processor is configured to display one of the screen of the broadcast video and the browser screen, and to display the other in the one of the screens.

5. The display device of claim 1, further comprising:
a management controller configured to store history information in which the address information represented by the two-dimensional code and program information of the broadcast video are associated with each other in storage, wherein
the display processor is configured to display the history information on the display.

6. The display device of claim 1, further comprising:
a camera, wherein
the recognition controller is configured to analyze a captured image obtained by the camera and recognize the two-dimensional code included in the captured image.

7. A display method comprising:
analyzing broadcast video comprising a two-dimensional code and recognizing the two-dimensional code;
converting the recognized two-dimensional code into address information;
accessing a web page indicated by the address information and displaying the web page on a browser screen; and
displaying a screen of the broadcast video and the browser screen on a display at the same time.
